(19) United States
(12) Patent Application Publication
(10) Pub. No.: US 2022/0053843 A1
(43) Pub. Date: Feb. 24, 2022

(54) PROTECTIVE CLOTHING

(71) Applicant: Chih-Fang Lo, Taichung City (TW)

(72) Inventor: Chih-Fang Lo, Taichung City (TW)

(21) Appl. No.: 17/000,360

(22) Filed: Aug. 23, 2020

(51) Int. Cl. A41D 13/002; A41D 13/11; A62B 17/00

(52) U.S. Cl. CPC A41D 13/0025; A41D 13/1153; A41D 2300/32; A41D 13/1184; A62B 17/006

(57) ABSTRACT

A protective clothing includes a first entrance in the front portion of the protective clothing, an operable portion in the hip section, two sleeve sections formed to the upper portion of the protective clothing, two leg sections formed to the lower portion of the protective clothing, multiple air orifices formed in sleeve sections and leg sections, a head mask removably connected to the upper portion of the protective clothing and having a transparent window, and an air blowing device attached to the protective clothing. The air blowing device sends air into the protective clothing, and the air releases from the air orifices to cool down the inside temperature the protective clothing.

### BACKGROUND OF THE INVENTION

### 1. Fields of the Invention

The present invention relates to a protective clothing, and more particularly, to a protective clothing to prohibit dust, germs and viruses from entering interior of the protective clothing to protect the wearers.

### 2. Descriptions of Related Art

The protective clothing is designed to protect the wearers from potential risks such as toxic dust, germs and viruses, so that the protective clothing focuses on how air enters into the interior of the protective clothing. One of the shortcomings of conventional protective clothing is that the ventilation feature to the wearers is poor so that the wearers are suffered by high humidity and high temperature. In order to improve this shortcoming, a hose is connected to the protective clothing and a compressor, fresh air can be sent into the protective clothing to provide air ventilation to the wearers. However, the hose and the compressor limit the range that the wearers can move.

The present invention intends to provide a protective clothing to eliminate the shortcomings mentioned above.

### SUMMARY OF THE INVENTION

The present invention relates to a protective clothing and comprises a front portion and a back portion, and a space is formed in the protective clothing. The protective clothing includes multiple air orifices, a first entrance, a head mask, an upper portion and a lower portion. The upper portion is formed between the head mask and the lower portion. A transparent window is formed to the head mask. The upper portion includes two first exits so that two hands extend through the two first exits. The lower portion includes two second exits so that two legs extend through the two second exits. Each of the first and second exits includes a tightened cuff. An air blowing device is attached to the protective clothing and includes an inlet, an outlet, a filtering layer and a power source. The inlet communicates with the space. The filtering layer is configured to filter air entering the room.

The primary object of the present invention is to provide a protective clothing that is equipped with an air blowing device. The air blowing device sends air into the protective clothing, and the air releases from the air orifices to cool down the inside temperature the protective clothing.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a front view of the protective clothing of the present invention;

FIG. 2 is a side view of the protective clothing of the present invention;

FIG. 3 is a rear side view of the protective clothing of the present invention;

FIG. 4 is a front view to illustrate a wearer wearing the protective clothing of the present invention;

FIG. 5 is a side view to illustrate a wearer wearing the protective clothing of the present invention;

FIG. 6 is a cross sectional view, taken along line VI-VI in FIG. 3;

FIG. 7 shows a second embodiment of the transparent window of the head mask of the protective clothing of the present invention;

FIG. 8 shows a third embodiment of the transparent window of the head mask of the protective clothing of the present invention;

FIG. 9 shows that another embodiment of the head mask and the protective clothing of the present invention, and

FIG. 10 shows that the head mask in FIG. 9 and the protective clothing of the present invention.

### DETAILED DESCRIPTION OF THE PREFERRED EMBODIMENT

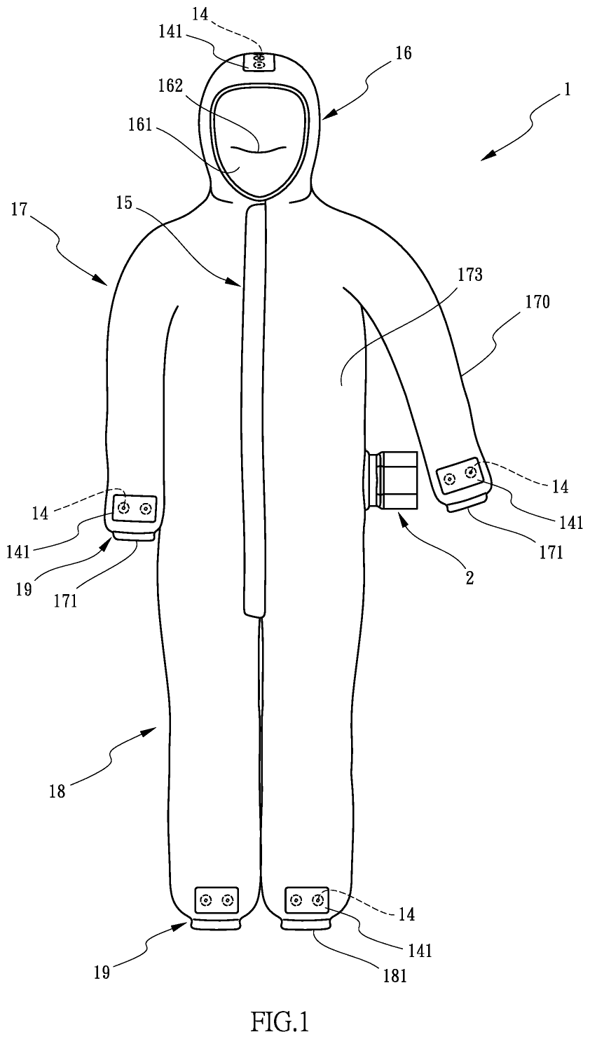

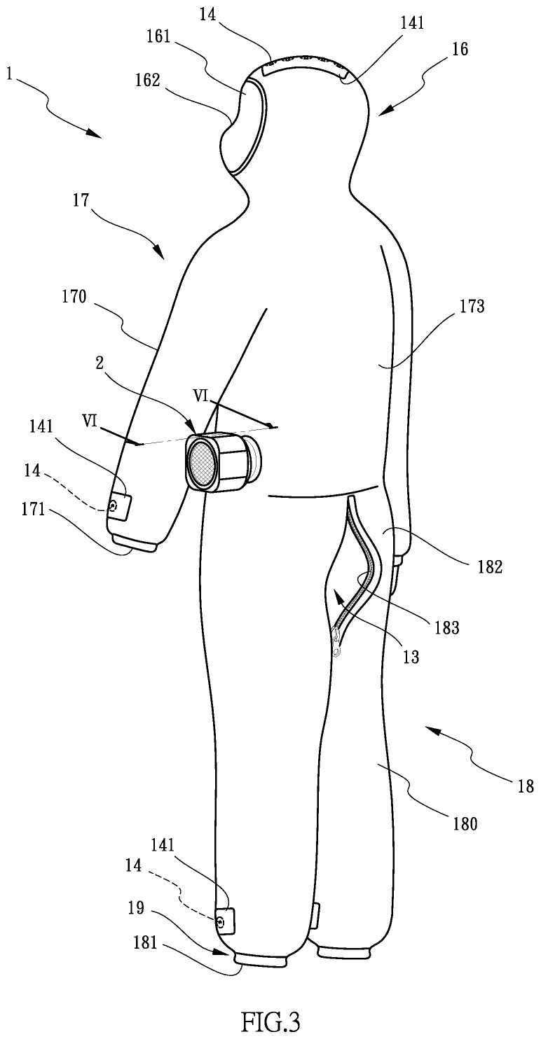

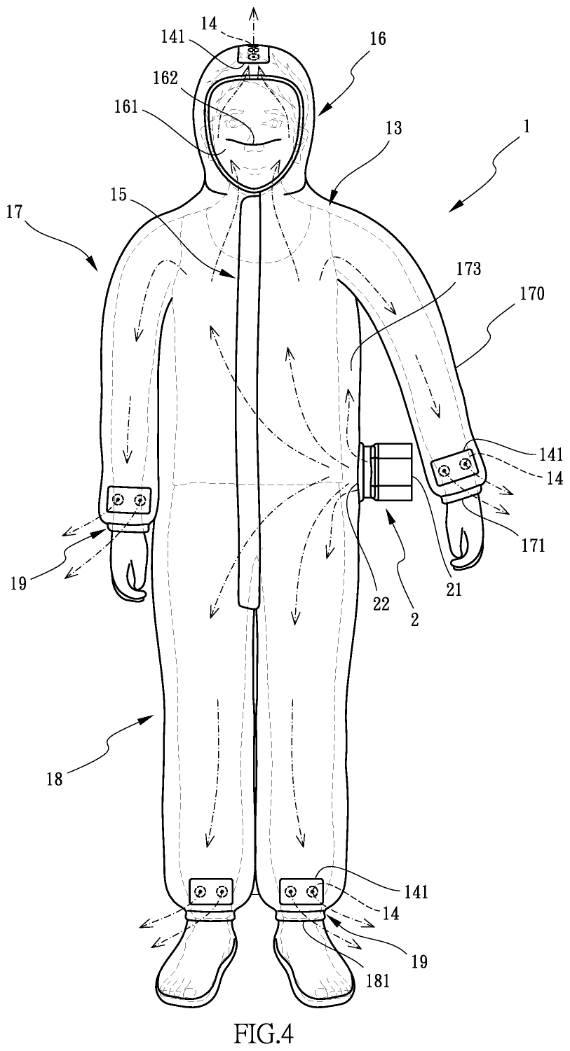

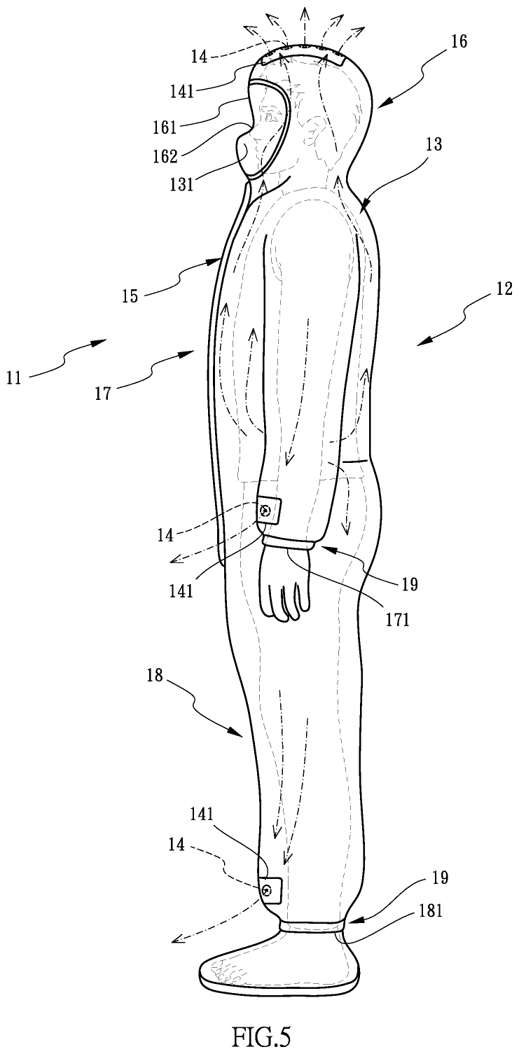

Referring to FIGS. 1 to 8, the protective clothing 1 of the present invention comprises a front portion 11 and a back portion 12, and a space 13 is formed in the protective clothing 1. The protective clothing 1 further includes multiple air orifices 14, a first entrance 15, a head mask 16, an upper portion 17 and a lower portion 18. The upper portion 17 is formed between the head mask 16 and the lower portion 18. A transparent window 161 is formed to the head mask 16 so that the wearer can see through the transparent window 161. Preferably, the transparent window 161 is connected to the head mask 16 by way of high frequency welding. The upper portion 17 includes two first exits 171 so that the two hands of the wearer extend through the two first exits 171, and the lower portion 18 includes two second exits 181 so that two legs extend through the two second exits 181. Each of the first and second exits 171, 181 includes a tightened cuff 19 which may have a stretchable band, snapping parts or any known tightening mechanism. The air orifices 14, the first and second exits 171, 181, and the first entrance 15 communicate with the space 13. In this embodiment, a portion of the air orifices 14 are located on a top of the head mask 16, a portion of the air orifices 14 are located close to the first exits 171, and a portion of the air orifices 14 are located close to the second exits 181. Each of the air orifices 14 has a check valve received therein so that air is prevented from entering the space 13 of the protective clothing 1 via the air orifices 14.

The first entrance 15 may be a zipper entrance so that the wearer can wear the protective clothing 1 of the present invention from the first entrance 15 from the front portion 11 of the protective clothing 1.

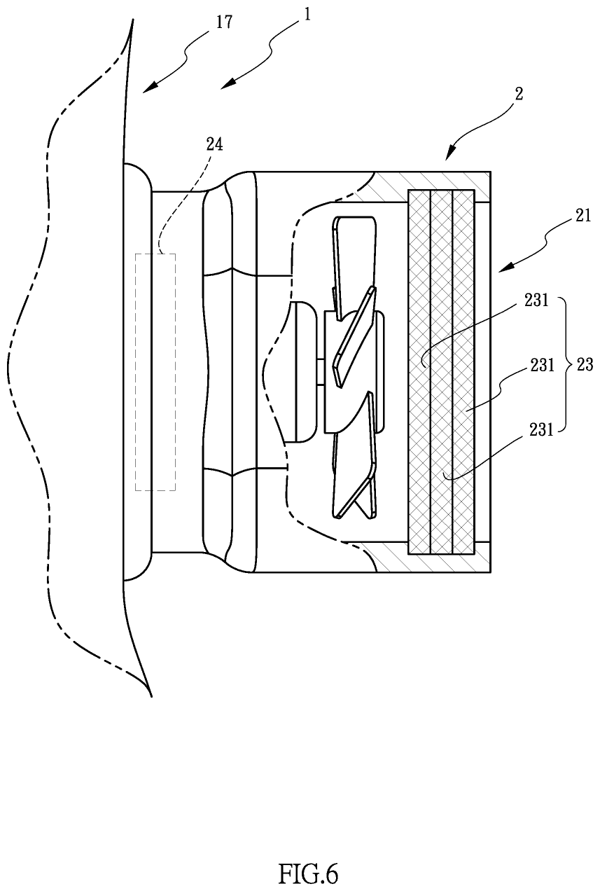

An air blowing device 2 is attached to the protective clothing 1 and includes an inlet 21, an outlet 22, a filtering layer 23 and a power source 24. The inlet 21 communicates with the space 13. The filtering layer 23 are configured to filter air entering the room 13. Preferably, the filtering layer 23 is located at the inlet 21 of the air blowing device 2, and the filtering layer 23 includes three laminated filtering sheets 231 as shown in FIG. 6. The air blowing device 2 can be connected with a fan. The power source 24 can be a battery or the like.

The upper portion 17 includes a body section 173 and two sleeve sections 170. The body section 173 is formed between the head mask 16 and the lower portion 18. The two first exits 171 are located to the two sleeve sections 170 respectively. The air blowing device 2 is attached to the upper portion 17 and located close to the lower portion 18. When the two sleeve sections 170 hangs downward, the air blowing device 2 is located close to one of the two sleeve sections 170 so that the wearer can easily replace a new power source 24 of the air blowing device 2.

The lower portion 18 includes a hip section 182 and two leg sections 180. The hip section 182 is formed with the upper portion 17. The two second exits 181 are respectively formed to two respective distal ends of the two leg sections 180. An openable portion 183 is formed to the hip section 182 of the back portion of the protective clothing 1 so that the wearer can use bathroom without taking off the protective clothing 1.

The air is sent into the space 13 via the air blowing device 2, and the air is released from the air orifices 14. The air is filtered by the filtering layer 23 to avoid from brining dust, germs and virus into the space 13. The pressure in the space 13 is larger than that of outside of the protective clothing 1, so that the air in the space 13 will release from the air orifices 14 to keep the wearer in the space 13 cool and comfortable.

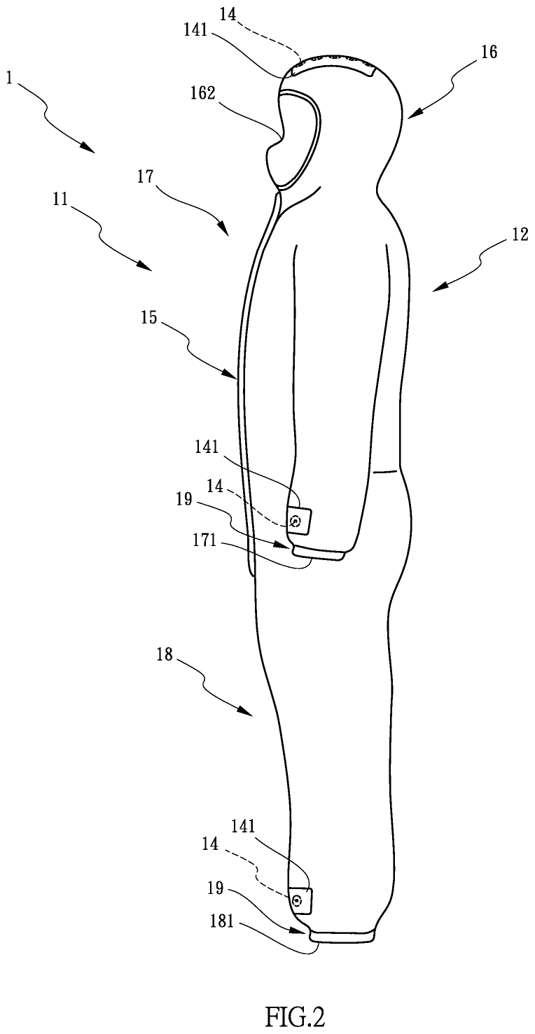

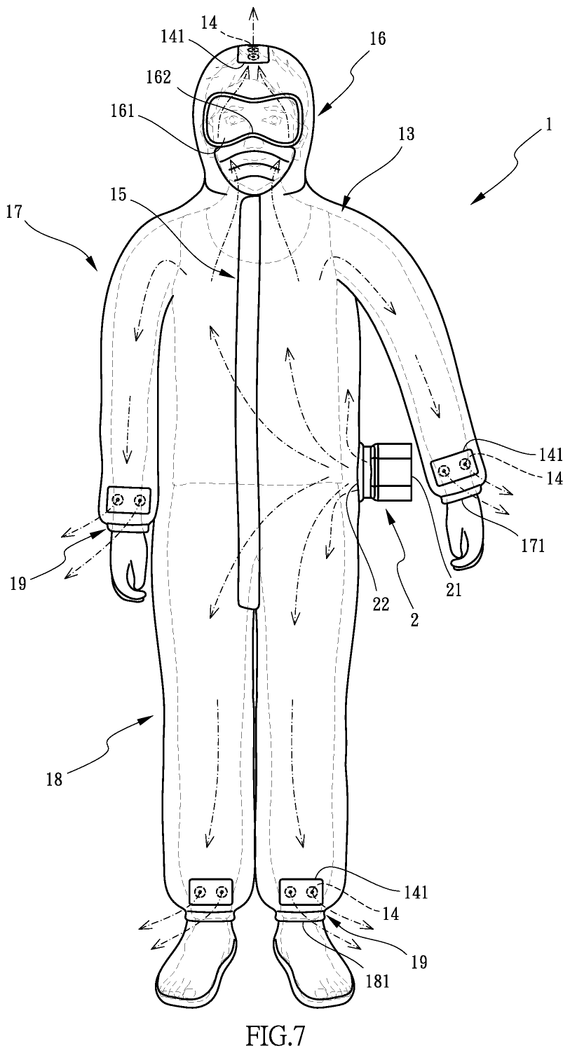

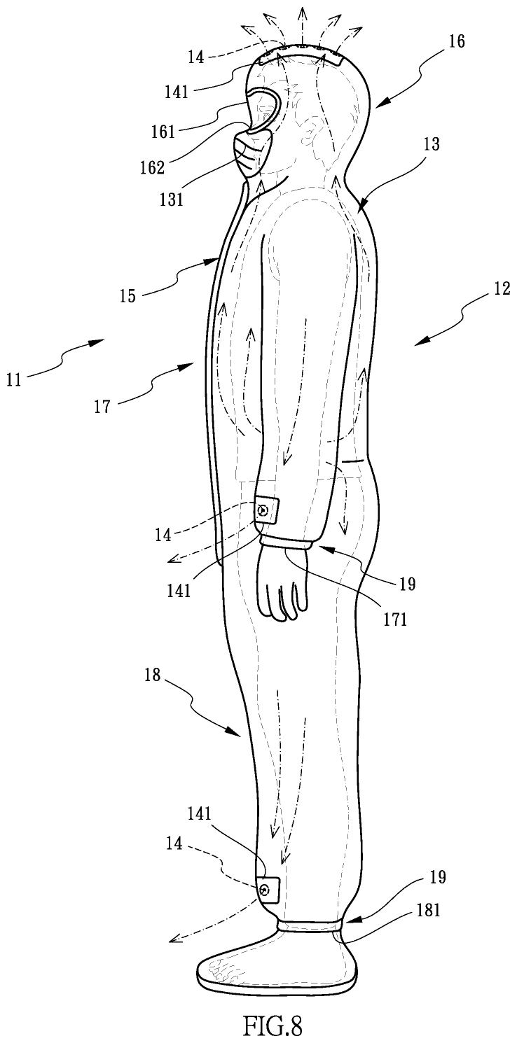

As shown in FIGS. 2, 3, 5 and 8, the head mask 16 includes a recessed area 162 formed to outside thereof, and a room 131 is formed in the head mask 16 and located between the recessed area 162 and the upper portion 17. The room 131 accommodates the wearer's nose and mouse. The hot air exhaled from the nose can be properly blocked by the recessed area 162 so that the hot air does not cause fog on the transparent window 161. The recessed area 162 and the room 131 are formed to the transparent window 161. Nevertheless, as shown in FIGS. 7 and 8, the transparent window 161 can have different shapes, and the recessed area 162 and the room 131 are formed to the head mush 16 instead to transparent window 161.

In addition, each of the air orifices 14 is covered by a filtering net 141 to further filter the air that releases from the air orifices 14. The wearer may carry virus but does not have symptoms, so that the air in the space 13 releases from the air orifices 14, the filtering net 141 is functioned to block the virus and germs from spreading into the air.

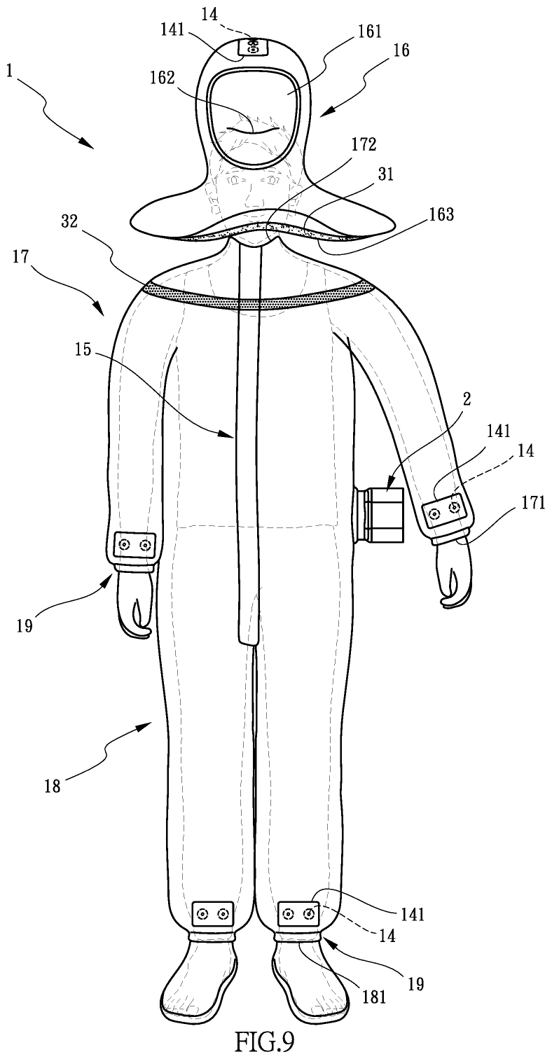

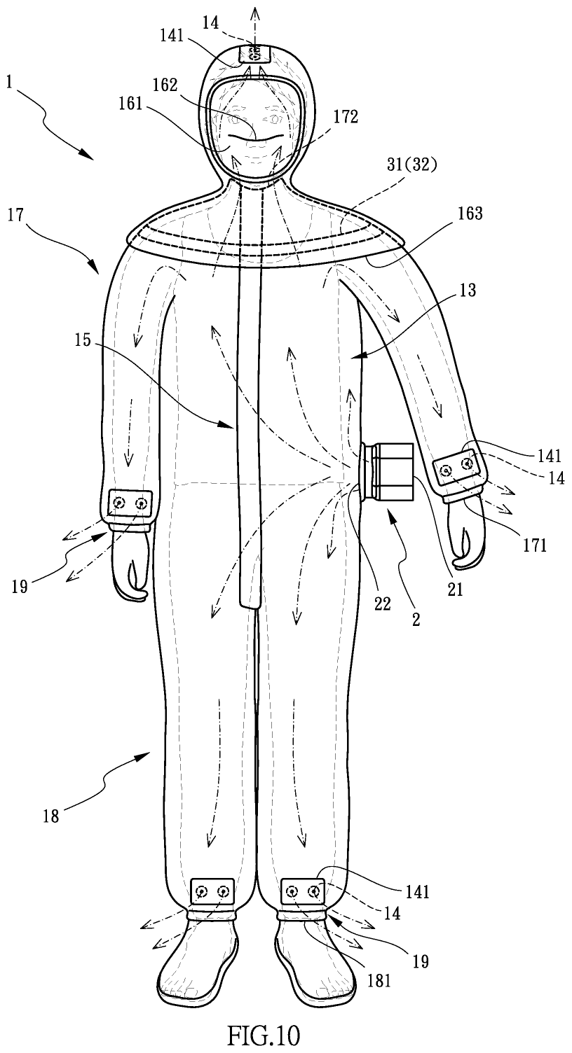

As shown in FIGS. 9 and 10, another embodiment of the head mask 16 is illustrated. The head mask 16 is removable from the upper portion 17 and includes a second entrance 161 formed to the lower end of the head mask 16. The upper portion 17 includes a third exit 172 facing the second entrance 161 so that the wearer's head extends through the third exit 172. The head mask 16 includes a skirt portion which extends outward from the lower portion of the head mask 16. The skirt portion is mounted to the shoulder portion of the upper portion 17 of the protective clothing 1. The second entrance 163 is located at the center of the skirt portion of the head mask 16. The inside of the second entrance 163 or the skirt portion includes a first loop-and-hook member 31, and the outside of the third exit 172 or the shoulder portion of the protective clothing 1 includes a second loop-and-hook member 32, so that the first loop-and-hook member 31 is connected to the second loop-and-hook member 32 when the head mask 16 is connected to the upper portion 17. The head mask 16 is mounted to the outside of the third exit 172.

The protective clothing 1 of the present invention provides an air-tight feature, and the air blowing device 2 keeps the wearer comfortable. The protective clothing 1 of the present invention eliminates the shortcomings of the conventional protective clothing.

While we have shown and described the embodiment in accordance with the present invention, it should be clear to those skilled in the art that further embodiments may be made without departing from the scope of the present invention.

What is claimed is:

1. A protective clothing comprising:
a front portion and a back portion, a space formed in the protective clothing, the protective clothing including multiple air orifices, a first entrance, a head mask, an upper portion and a lower portion, the upper portion formed between the head mask and the lower portion, a transparent window formed to the head mask, the upper portion including two first exits so that two hands extend through the two first exits, the lower portion including two second exits so that two legs extend through the two second exits, each of the first and second exits including a tightened cuff, and
an air blowing device attached to the protective clothing and including an inlet, an outlet, a filtering layer and a power source, the inlet communicating with the space, the filtering layer configured to filter air entering the room.

2. The protective clothing as claimed in claim 1, wherein the head mask includes a recessed area formed to outside thereof, a room is formed in the head mask and located between the recessed area and the upper portion, the room is configured to accommodate a wearer's nose and mouse.

3. The protective clothing as claimed in claim 2, wherein a portion of the air orifices are located on a top of the head mask, a portion of the air orifices are located close to the first exits, and a portion of the air orifices are located close to the second exits.

4. The protective clothing as claimed in claim 1, wherein the upper portion includes a body section and two sleeve sections, the body section is formed between the head mask and the lower portion, the two first exits are located to the two sleeve sections respectively, the air blowing device is attached to the upper portion and located close to the lower portion, when the two sleeve sections hangs downward, the air blowing device is located close to one of the two sleeve sections.

5. The protective clothing as claimed in claim 1, wherein the filtering layer is located at the inlet of the air blowing device, the filtering layer includes three laminated filleting sheets.

6. The protective clothing as claimed in claim 1, wherein the air orifices each have a check valve received therein so that air is prevented from entering the space of the protective clothing is the air orifices.

7. The protective clothing as claimed in claim 1, wherein the transparent window is connected to the head mask by way of high frequency welding.

8. The protective clothing as claimed in claim 1, wherein the air orifices are covered by a filtering net.

9. The protective clothing as claimed in claim 1, wherein the bead mask is removable from the upper portion and includes a second entrance formed to a lower end of the head mask, the upper portion includes a third exit facing the second entrance so that a wearer's head extends through the third exit, an inside of the second entrance includes a first loop-and-hook member, an outside of the third exit includes a second loop-and-hook member, the first loop-and-hook member is connected to the second loop-and-hook member when the head mask is connected to the upper portion, the head mask is mounted to the outside of the third exit.

10. The protective clothing as claimed in claim 1, wherein the lower portion includes a hip section and two leg sections, the hip section is formed with the upper portion, the two second exits are respectively formed to two respective distal ends of the two leg sections, an openable portion is formed to the hip section of the back portion of the protective clothing.
